(19) United States
(12) Patent Application Publication
(10) Pub. No.: US 2019/0234405 A1
(43) Pub. Date: Aug. 1, 2019

(54) PUMP DEVICE

(71) Applicant: Nidec Tosok Corporation, Zama-shi, Kanagawa (JP)

(72) Inventors: Kazuhiro HOMMA, Zama-shi (JP); Yosuke ITO, Zama-shi (JP)

(21) Appl. No.: 16/334,775

(22) PCT Filed: Sep. 25, 2017
(86) PCT No.: PCT/JP2017/034562

§ 371 Date: Mar. 20, 2019

(30) Foreign Application Priority Data
Sep. 30, 2016 (JP) 2016-195272

(51) Int. Cl. F04C 15/00; F04C 2/10; H02K 1/04; H02K 1/20; H02K 1/32; H02K 5/167; H02K 5/20; H02K 7/08; H02K 9/193; H02K 16/02

(52) U.S. Cl. CPC F04C 15/0096; F04C 2/10; H02K 1/04; H02K 1/20; H02K 1/32; F04C 2240/40; H02K 5/20; H02K 7/085; H02K 9/193; H02K 16/02; H02K 5/1675

(57) ABSTRACT

A pump device includes a shaft, a motor that rotates the shaft, and a pump driven by the motor through the shaft to discharge oil. The pump device includes a first passage that sucks oil from an intake opening of the motor, a second passage which is provided between a stator and a rotor, and a third passage connected from the second passage to a negative pressure region inside the pump, and the pump discharges oil flowing from the third passage to the pump from the discharge opening.

### TECHNICAL FIELD

The present disclosure relates to a pump device.

### BACKGROUND ART

In recent years, an electric oil pump used in a transmission or the like requires responsiveness. In order to realize the responsiveness of the electric oil pump, a motor for the electric oil pump needs to have a high output.

When the motor for the electric oil pump is designed to have a high output, a large current flows to a coil of the motor so that the motor increases in temperature and, for example, a permanent magnet of the motor is demagnetized. For that reason, there is a need to provide a cooling structure in the motor in order to prevent an increase in temperature of the motor.

Japanese Unexamined Patent Application, Publication No. 2008-125235 discloses an electric motor with an oil supply mechanism which changes a relative positional relationship between a stator and a rotor in the axial direction by an oil pressure in response to a rotation speed of the rotor and cools the rotor by oil.

However, the electric motor disclosed in Japanese Unexamined Patent Application, Publication No. 2008-125235 is not able to simultaneously cool the stator and the rotor by oil.

### SUMMARY OF THE DISCLOSURE

Example embodiments of the present disclosure provide pump devices each capable of realizing a structure with a high cooling effect by simultaneously cooling a stator and a rotor.

A first example embodiment of the present disclosure provides a pump device including a shaft which rotates about a center axis extending in an axial direction, a motor that rotates the shaft, and a pump that is located at one side of the motor in the axial direction and is driven by the motor through the shaft to discharge oil, wherein the motor includes a rotor that rotates about the shaft, a stator facing the rotor, a housing that accommodates the rotor and the stator, and an intake opening that is provided in the housing to suck the oil, wherein the pump includes a pump rotor attached to the shaft, a pump casing that accommodates the pump rotor, and a discharge opening that is provided in the pump casing and discharges the oil, wherein the pump device further includes a first passage that sucks oil from an intake opening of the motor, a second passage provided between the stator and the rotor, and a third passage connected from the second passage to a negative pressure region inside the pump, and the pump discharges the oil flowing from the third passage to the pump from the discharge opening.

According to a first example embodiment of the present disclosure, it is possible to provide a pump device including a structure that achieves a high cooling effect by simultaneously cooling a stator and a rotor.

The above and other elements, features, steps, characteristics and advantages of the present disclosure will become more apparent from the following detailed description of example embodiments with reference to the attached drawings.

### BRIEF DESCRIPTION OF THE DRAWINGS

FIG. 1 is a cross-sectional view showing a pump device according to a first example embodiment of the present disclosure.

FIG. 2 is a diagram showing a pump body when viewed from a front side in the axial direction.

FIG. 3 is a diagram schematically showing a main portion of the pump device according to the first example embodiment of the present disclosure.

FIG. 4 is a top view of a stator of the first example embodiment of the present disclosure.

FIG. 5 is a diagram showing a modified example of an intake opening of the first example embodiment of the present disclosure.

FIG. 6 is a diagram showing a modified example of the intake opening of the first example embodiment of the present disclosure.

FIG. 7A is a diagram showing a modified example of the intake opening of the first example embodiment of the present disclosure.

FIG. 7B is a diagram showing a modified example of the intake opening of the first example embodiment of the present disclosure.

FIG. 8 is a cross-sectional view showing a pump device according to a second example embodiment of the present disclosure.

FIG. 9 is a cross-sectional view showing a pump device according to a third example embodiment of the present disclosure.

### DESCRIPTION OF THE EXAMPLE EMBODIMENTS

Hereinafter, pump devices according to example embodiments of the present disclosure will be described with reference to the drawings. Furthermore, the scope of the disclosure is not limited to the example embodiments below and can be arbitrarily changed within the technical spirit of the disclosure. Further, in the drawings below, in order to easily understand each component, there are cases in which scales, numbers, and the like of structures are different from those of the actual structures.

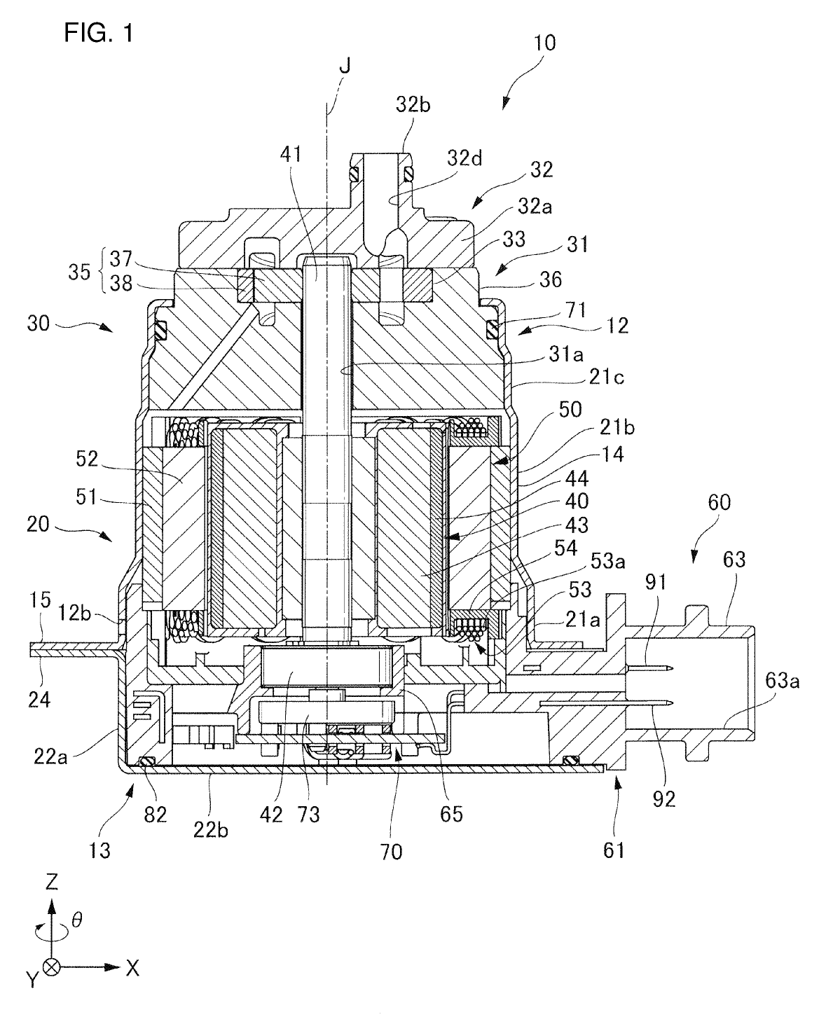

Further, in the drawings, an XYZ coordinate system is appropriately shown as a three-dimensional orthogonal coordinate system. In the XYZ coordinate system, the Z-axis direction is set as a direction which is parallel to one direction of the axial direction of the center axis J shown in FIG. 1. The X-axis direction is set as a direction which is parallel to the longitudinal direction of a bus bar assembly 60 shown in FIG. 1, that is, the right to left direction of FIG. 1. The Y-axis direction is set as a direction which is parallel to the width direction of the bus bar assembly 60, that is, a direction orthogonal to both the X-axis direction and the Z-axis direction.

Further, in the following description, a positive side (+Z side) of the Z-axis direction will be referred to as the “front side” and a negative side (−Z side) of the Z-axis direction will be referred to as the “rear side”. Furthermore, the rear side and the front side are names simply used for a description and do not limit the actual positional relationship or direction. Further, unless otherwise specified, a direction (the Z-axis direction) which is parallel to the center axis J will be simply referred to as the “axial direction”, the radial direction around the center axis J will be simply referred to as the “radial direction”, and the circumferential direction around the center axis J, that is, a direction (a θ direction) around the center axis J will be simply referred to as the “circumferential direction”.

Furthermore, in the present specification, an extension in the axial direction precisely includes an extension in a direction inclined by a range smaller than 45° with respect to the axial direction in addition to an extension in the axial direction (the Z-axis direction). Further, in the present specification, an extension in the radial direction precisely includes an extension in a direction inclined by a range smaller than 45° with respect to the radial direction in addition to an extension in the radial direction, that is, a direction perpendicular to the axial direction (the Z-axis direction).

### First Example Embodiment

FIG. 1 is a cross-sectional view showing a pump device 10 of this example embodiment.

The pump device 10 of this example embodiment includes a shaft 41, a motor unit 20, a housing 12, a cover 13, and a pump unit 30. The shaft 41 rotates about the center axis J extending in the axial direction. The motor unit 20 and the pump unit 30 are arranged side by side in the axial direction.

The motor unit 20 includes, as shown in FIG. 1, a cover 13, a rotor 40, a stator 50, a bearing 42, a control device 70, a bus bar assembly 60, and a plurality of O-rings. Each of the plurality of O-rings includes at least a rear side O-ring 82.

The rotor 40 is fixed to the outer peripheral surface of the shaft 41. The stator 50 is located at the outside of the rotor 40 in the radial direction. That is, the motor unit 20 is an inner rotor type motor. The bearing 42 rotatably supports the shaft 41. The bearing 42 is held by the bus bar assembly 60. The bus bar assembly 60 is connected to an external power supply and supplies a current to the stator 50.

The housing 12 holds the motor unit 20 and the pump unit 30. The housing 12 opens to the rear side (−Z side) and an end portion of the front side (+Z side) of the bus bar assembly 60 is inserted into the opening portion of the housing 12. The cover 13 is fixed to the rear side of the housing 12. The cover 13 covers the rear side of the motor unit 20. That is, the cover is fixed to the housing 12 to cover at least a part of the rear side (-Z side) of the bus bar assembly 60. Furthermore, hereinafter, there is a case in which one including the cover 13 is called the housing 12.

The control device 70 is disposed between the bearing 42 and the cover 13. The rear side 0-ring 82 is provided between the bus bar assembly 60 and the cover 13. Hereinafter, each component will be described in detail.

### Housing

As shown in FIG. 1, the housing 12 has a cylindrical shape. More specifically, the housing 12 has a multi-stage cylindrical shape which is formed about the center axis J so that both ends are opened. The material of the housing 12 is, for example, metal. The housing 12 holds the motor unit 20 and the pump unit 30. The housing 12 includes a cylindrical portion 14 and a flange portion 15.

The flange portion 15 extends from the rear side end portion of the cylindrical portion 14 to the outside in the radial direction. The cylindrical portion 14 has a cylindrical shape about the center axis J. The cylindrical portion 14 includes a bus bar assembly insertion portion 21a, a stator holding portion 21b, and a pump body holding portion 21c in the axial direction (the Z-axis direction) in order from the rear side (−Z side) to the front side (+Z side).

The bus bar assembly insertion portion 21a surrounds the end portion of the front side (+Z side) of the bus bar assembly 60 from the outside of the radial direction of the center axis J. The bus bar assembly insertion portion 21a, the stator holding portion 21b, and the pump body holding portion 21c are respectively formed in a concentric cylindrical shape and the diameters thereof decrease in this order.

That is, the front side end portion of the bus bar assembly 60 is located inside the housing 12. An outer surface of the stator 50, that is, an outer surface of a core back portion 51 to be described later is fitted to an inner surface of the stator holding portion 21b. Accordingly, the stator 50 is held by the housing 12. An outer peripheral surface of the pump body 31 is fixed to an inner peripheral surface of the pump body holding portion 21c.

The housing 12 includes an intake opening 12b. The intake opening 12b sucks oil discharged from a discharge opening 32d by the pump unit 30 to be described later. In the example shown in FIG. 1, the intake opening 12b is provided in the cylindrical portion 14 (housing side surface). Specifically, the intake opening 12b is provided in a cylindrical portion 14 of the housing 12 (a side surface of the housing) and is located at one end of the stator opposite to the pump unit in the axial direction, that is, a position between a rear side end portion of the stator 50 and a rear side end portion (a bottom portion) of the housing 12. The rear side end portion (the bottom portion) of the housing 12 is set as a front side end portion for the control device 70 and the bus bar assembly 60.

That is, the intake opening 12b is provided in a side surface of the housing 12 and is located at the front side in relation to the control device 70 and the bus bar assembly 60 in the axial direction. Since the intake opening 12b is provided at the above-described position, oil can smoothly flow through a second passage inside the motor unit 20 to be described later. That is, since an optimal passage can be provided, it is possible to efficiently spread oil throughout the stator 50. For this reason, the stator 50 can be efficiently cooled.

Furthermore, the position of the intake opening 12b is not limited thereto. The intake opening 12b may be provided at an arbitrary position of the housing 12 or may be provided in the cover 13. For example, in a case in which the control device and the bus bar assembly are attached to the side surface of the motor unit 20, the intake opening 12b may be provided in the cover 13. When the intake opening 12b is provided in the cover 13 in a case in which the control device and the bus bar assembly are attached to the side surface of the motor unit 20, a lid portion 22b of the cover 13 is formed as the bottom portion of the housing and a cylindrical portion 22a of the cover 13 is included in the side surface of the housing.

The position of the intake opening 12b may be determined in response to a position of an external device to which the pump device 10 is attached. For example, a case in which the pump device 10 is attached to, for example, CVT (Continuously Variable Transmission) according to the following arrangement will be supposed. The pump device 10 is disposed so that the axial direction of the pump device 10 becomes a horizontal direction, a positive side (+X side) of the X-axis direction with respect to the shaft 41 becomes the upper side, and a negative side (−X side) of the X-axis direction becomes the lower side.

Oil discharged from the discharge opening 32d of the pump unit 30 flows into the motor unit 20 from the intake opening 12b of the motor unit 20 through the CVT and returns to the pump unit 30. In a case in which the oil passage from the CVT to the motor unit 20 in the circulation of the oil is located at the upper side (+Z side) in the arrangement of the pump device 10, the intake opening 12b is also provided at the upper side in this way. Since the oil sucked from the intake opening 12b can be circulated inside the entire motor unit 20 while flowing in the direction of gravity, it is possible to more efficiently circulate the oil. Furthermore, the position of the intake opening 12b may be the lower side (−X side) with respect to the shaft 41 in response to the arrangement of the pump device 10.

The number of the intake openings 12b is not limited to one but may be plural. When the intake openings 12b are provided at a plurality of positions, more oil can flow (to be sucked) into the motor unit 20. For this reason, even when the amount of the oil discharged from the pump is large, it is possible to secure an optimal oil suction amount inside the motor. Since the optimal oil suction amount is secured, the stator and the rotor can be cooled optimally in a cooling structure to be described later.

### Rotor

The rotor 40 includes a rotor core 43 and a rotor magnet 44. The rotor core 43 is fixed to the shaft 41 to surround the shaft 41 about the axis (the θ direction). The rotor magnet 44 is fixed to an outer surface along the axis of the rotor core 43. The rotor core 43 and the rotor magnet 44 rotate together with the shaft 41.

### Stator

The stator 50 rotates the rotor 40 about the center axis J while surrounding the rotor 40 around the axis (the θ direction). The stator 50 includes a core back portion 51, a tooth portion 52, a coil 53, and a bobbin (an insulator) 54. The shape of the core back portion 51 has a cylindrical shape concentric with the shaft 41.

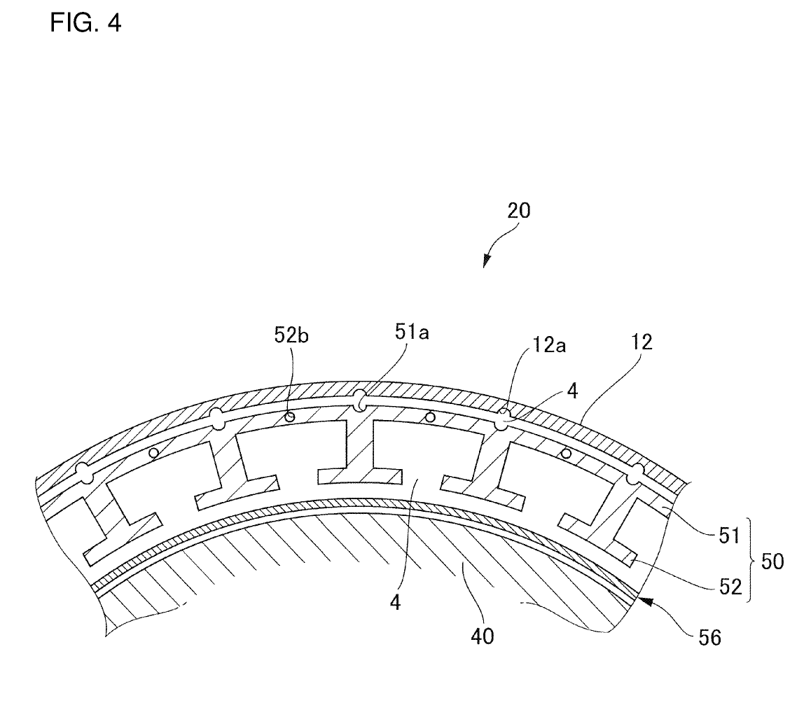

The tooth portion 52 extends from the inner surface of the core back portion 51 toward the shaft 41. The teeth portion 52 is provided at a plurality of positions and the tooth portions are arranged at the same interval in the circumferential direction of the inner surface of the core back portion 51 (FIG. 4). The coil 53 is configured by winding a conductive wire 53a. The coil 53 is provided in a bobbin (an insulator) 54. The bobbin (the insulator) 54 is attached to each tooth portion 52.

### Bearing

The bearing 42 is disposed at the rear side (-Z side) of the stator 50. The bearing 42 is held by a bearing holding portion 65 of a bus bar holder 61 to be described later. The bearing 42 supports the shaft 41. The configuration of the bearing 42 is not particularly limited and any known bearing may be used.

### Control Device

The control device 70 controls the driving of the motor unit 20. The control device 70 includes a circuit board (not shown), a rotation sensor (not shown), a sensor magnet holding member (not shown), and a sensor magnet 73. That is, the motor unit 20 includes the circuit board, the rotation sensor, the sensor magnet holding member, and the sensor magnet 73.

The circuit board outputs a motor driving signal. The sensor magnet holding member is positioned while the center hole is fitted to a small diameter portion of the end portion of the rear side (+Z side) of the shaft 41. The sensor magnet holding member is rotatable along with the shaft 41. The sensor magnet 73 has an annular shape and N and S poles are alternately arranged in the circumferential direction. The sensor magnet 73 is fitted to the outer peripheral surface of the sensor magnet holding member.

Accordingly, the sensor magnet 73 is held by the sensor magnet holding member and is disposed at the rear side (−Z side) of the bearing 42 to be rotatable about the axis of the shaft 41 (the +θ direction) along with the shaft 41.

The rotation sensor is attached to a front surface of a circuit board at the front side (+Z side). The rotation sensor is provided at a position facing the sensor magnet 73 in the axial direction (the Z-axis direction). The rotation sensor detects a change in magnetic flux of the sensor magnet 73. The rotation sensor is, for example, a Hall IC or MR sensor. Specifically, in a case in which the Hall IC is used, three Hall ICs are provided.

### Cover

The cover 13 is attached to the rear side (−Z side) of the housing 12. The material of the cover 13 is, for example, metal. The cover 13 includes a cylindrical portion 22a, a lid portion 22b, and a flange portion (a cover side) 24. The cylindrical portion 22a opens to the front side (+Z side).

The cylindrical portion 22a surrounds the bus bar assembly 60, more specifically, the end portion of the rear side (−Z side) of the bus bar holder 61 from the outside of the radial direction of the center axis J. The cylindrical portion 22a is connected to the rear side end portion of the bus bar assembly insertion portion 21a in the housing 12 through the flange portion (the housing side) 15 and the flange portion (the cover side) 24.

The lid portion 22b is connected to the rear side end portion of the cylindrical portion 22a. In this example embodiment, the lid portion 22b has a flat plate shape. The lid portion 22b blocks the rear side opening portion of the bus bar holder 61. The front side surface of the lid portion 22b is in contact with the entire circumference of the rear side O-ring 82. Accordingly, the cover 13 is indirectly contact with a body rear surface at the rear side of the bus bar holder 61 through the rear side O-ring 82 over the entire circumference of the opening portion of the bus bar holder 61.

The flange portion (the cover side) 24 is widened outward in the radial direction from the front side end portion of the cylindrical portion 22a. The housing 12 and the cover 13 are bonded to each other while the flange portion (the housing side) 15 overlaps the flange portion (the cover side) 24.

An external power supply is connected to the motor unit 20 through a connector portion 63. The connected external power supply is electrically connected to a bus bar 91 and a wiring member 92 protruding from a bottom surface of a power supply opening portion 63a of the connector portion 63. Accordingly, a driving current is supplied to the rotation sensor and the coil 53 of the stator 50 through the bus bar 91 and the wiring member 92. The driving current supplied to the coil 53 is controlled in response to, for example, the rotation position of the rotor 40 measured by the rotation sensor. When the driving current is supplied to the coil 53, a magnetic field is generated and the rotor 40 is rotated by the magnetic field. In this way, the motor unit 20 obtains a rotational driving force.

### Pump Unit

The pump unit 30 is located at one side of the axial direction, specifically, the front side (+Z side) of the motor unit 20. The pump unit 30 is driven by the motor unit 20 through the shaft 41. The pump unit 30 includes a pump casing and a pump rotor 35. The pump casing includes a pump body 31 and a pump cover 32. Hereinafter, the pump cover 32 and the pump body 31 will be referred to as a pump casing.

The pump body 31 is fixed into the housing 12 at the front side of the motor unit 20. The O-ring 71 is attached to the pump body 31. The O-ring 71 is provided between the outer peripheral surface of the pump body 31 and the inner peripheral surface of the housing 12 in the radial direction. Accordingly, a gap between the outer peripheral surface of the pump body 31 and the inner peripheral surface of the housing 12 in the radial direction is sealed. The pump body 31 includes a pump chamber 33 which is recessed from a surface at the front side (the +Z side and one side of the axial direction) toward the rear side (the -Z side and the other side of the axial direction) and accommodates the pump rotor 35. A shape of the pump chamber 33 when viewed from the axial direction is a circular shape.

The pump body 31 includes a through-hole 31a which opens to both ends in the axial direction so that the shaft 41 passes therethrough and the front side opening opens to the pump chamber 33. The rear side opening of the through-hole 31a opens to the motor unit 20. The through-hole 31a serves as a bearing member that rotatably supports the shaft 41.

The pump body 31 includes an exposed portion 36 which is located at the front side in relation to the housing 12 and is exposed to the outside of the housing 12. The exposed portion 36 is a portion of the front side end portion of the pump body 31. The exposed portion 36 has a columnar shape which extends in the axial direction. The exposed portion 36 overlaps the pump chamber 33 in the radial direction.

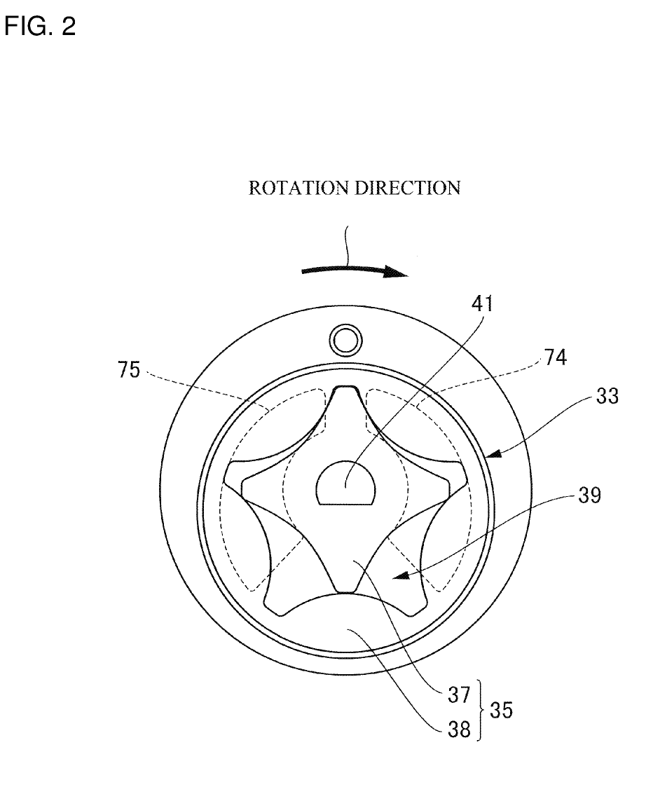

The pump unit 30 is a displacement type pump which pressure-feeds oil while a volume of a sealed space (oil chamber) expands and contracts and is, in this example embodiment, a trochoid pump. FIG. 2 is a diagram showing the pump body 31 when viewed from the front side of the axial direction. The pump rotor 35 is attached to the shaft 41. More specifically, the pump rotor 35 is attached to the front side end portion of the shaft 41.

The pump rotor 35 includes an inner rotor 37 which is attached to the shaft 41 and an outer rotor 38 which surrounds the outside of the inner rotor 37 in the radial direction. The inner rotor 37 has an annular shape. The inner rotor 37 is a gear which has teeth formed on an outer surface in the radial direction. The inner rotor 37 is fixed to the shaft 41. More specifically, the front side end portion of the shaft 41 is press-inserted into the inner rotor 37. The inner rotor 37 rotates about the axis (the θ direction) along with the shaft 41.

The outer rotor 38 has an annular shape which surrounds the outside of the inner rotor 37 in the radial direction. The outer rotor 38 is a gear which has teeth formed on an inner surface in the radial direction. The outer rotor 38 is accommodated inside the pump chamber 33 to be rotatable. An inner accommodation chamber 39 which accommodates the inner rotor 37 is formed in the outer rotor 38 and the inner accommodation chamber 39 is formed in a star shape. The inner rotor 37 is accommodated in the inner accommodation chamber 39 to be rotatable.

The number of the inner teeth of the outer rotor 38 is set to be larger than the number of outer teeth of the inner rotor 37. When the inner rotor 37 is rotated by the shaft 41 while the inner rotor 37 engages with the outer rotor 38, the outer rotor 38 rotates in accordance with the rotation of the inner rotor 37. That is, the pump rotor 35 rotates in accordance with the rotation of the shaft 41. In other words, the motor unit 20 and the pump unit 30 have the same rotation shaft. Accordingly, it is possible to prevent an increase in size of the electric oil pump in the axial direction.

When the inner rotor 37 and the outer rotor 38 rotate, a volume of a space formed between the inner rotor 37 and the outer rotor 38 changes in response to a rotation position. The pump rotor 35 is configured to suck oil from the intake port 74 by using a change in volume and to discharge the oil from a discharge port 75 by pressurizing the sucked oil. In this example embodiment, a region of which a volume increases (oil is sucked) in a space formed between the inner rotor 37 and the outer rotor 38 will be defined as a negative pressure region.

Furthermore, the pump unit 30 is not limited to the trochoid pump but may be other types of pumps as long as the pump is a displacement type pump which pressure-feeds oil when a volume of a sealed space (oil chamber) expands and contracts. For example, the pump unit 30 may be a vane pump. In a case in which the pump unit 30 is a vane pump, a cylindrical rotor (not shown) fixed to the shaft 41 is accommodated in the pump chamber 33. The rotor (not shown) includes a plurality of slots and a vane which is slidably attached to the slot. The outer periphery of the rotor is eccentrically disposed with respect to the inner periphery of the pump chamber 33 so that a crescent space is formed between the pump chamber 33 and the rotor.

The crescent space which is formed between the pump chamber 33 and the rotor is defined into a plurality of regions by the slots attached to the rotor. When the rotor rotates so that the vanes attached to the slots move forward and backward, the volume of each region changes in response to the rotation position. By using a change in volume as in the case of the trochoid pump, oil can be sucked from an intake port (not shown) and the sucked oil can be pressurized and discharged from a discharge port (not shown). Among the regions formed between the rotor and the pump chamber 33, a region in which a volume increases (oil is sucked) corresponds to the negative pressure region. During the operation of the pump device 10, a region (a region in the vicinity of the discharge opening 32d) in which a volume decreases has a pressure higher than that of a region (a region into which oil is sucked) in which a volume increases.

The pump cover 32 is attached to the front side of the pump body 31. The pump cover 32 includes a pump cover body 32a and a pump discharge cylindrical portion 32b. The pump cover body 32a has a disk shape which is widened in the radial direction. The pump cover body 32a blocks the front side opening of the pump chamber 33. The pump discharge cylindrical portion 32b has a cylindrical shape which extends in the axial direction. The pump discharge cylindrical portion 32b opens to both ends in the axial direction. The pump discharge cylindrical portion 32b extends from the pump cover body 32a to the front side.

The pump unit 30 includes the discharge opening 32d. The discharge opening 32d is provided in the pump cover 32. The discharge opening 32d includes the inside of the pump discharge cylindrical portion 32b. The discharge opening 32d opens to the front side surface of the pump cover 32. The discharge opening 32d is connected to the discharge port 75 of the pump chamber 33 (see FIG. 2) and is able to discharge oil from the pump chamber 33.

Oil sucked from the intake opening 12b of the motor unit 20 is sucked to the pump chamber 33 of the pump unit 30 through a passage to be described later. The oil sucked to the pump chamber 33 is sent by the pump rotor 35 and is discharged to the discharge opening 32d.

Next, a cooling structure of the pump device 10 according to this example embodiment will be described. According to this example embodiment, the oil supplied to the pump chamber 33 is discharged from the discharge opening 32d by the pump rotor 35, passes through an external device, and circulates inside the motor unit 20 through the intake opening 12b of the motor unit 20 to simultaneously cool the stator 50 and the rotor 40.

The oil circulating in the motor unit 20 is returned to the pump chamber 33 and the pump rotor 35 discharges the oil returned from the motor unit 20 from the discharge opening 32d. According to this example embodiment, since it is possible to circulate oil from the pump unit to the motor unit through a series of passages, it is possible to simultaneously cool the stator and the rotor without decreasing the pump efficiency.

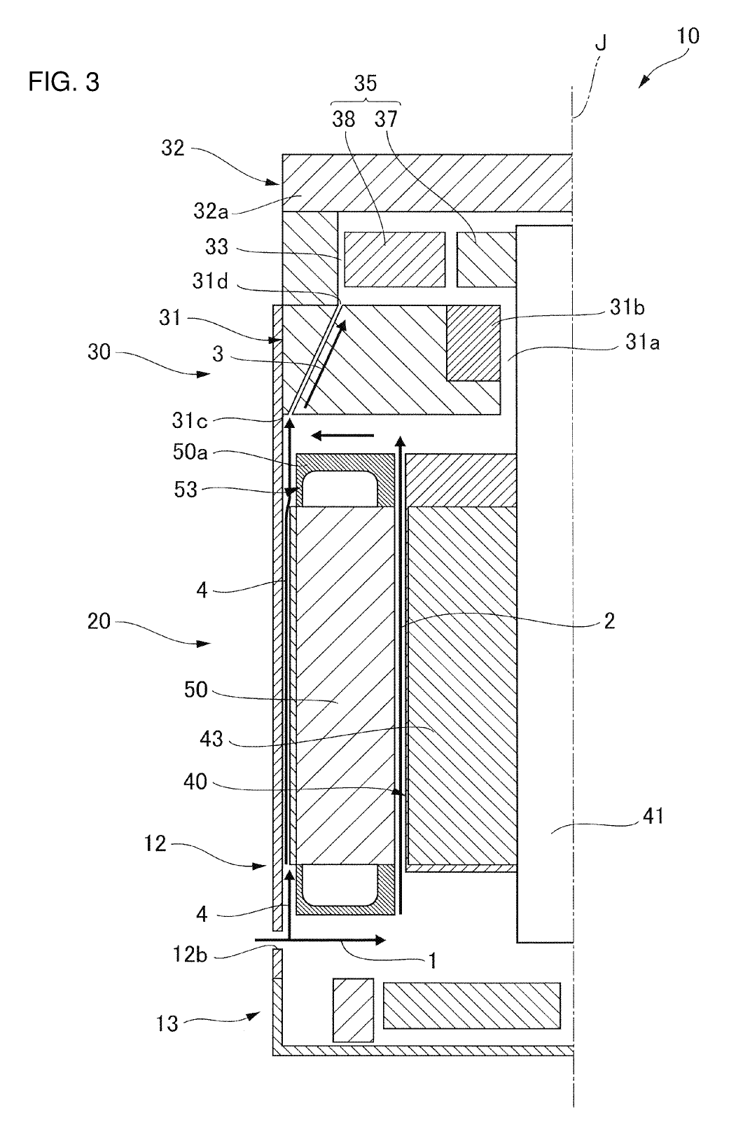

FIG. 3 is a schematic diagram showing a main part of the pump device 10 in order to easily understand the oil passage of the pump device 10 shown in FIG. 1.

As shown in FIG. 3, the pump device 10 includes a first passage 1 which sucks oil from the intake opening 12b of the motor unit 20, a second passage 2 which is provided between the stator 50 and the rotor 40, and a third passage 3 which is connected from the second passage 2 to the negative pressure region inside the pump unit 30. The pump unit 30 discharges the oil flowing from the third passage 3 to the pump unit 30 (the pump chamber 33) from the discharge opening 32d. Hereinafter, each passage will be described in detail.

### First Passage

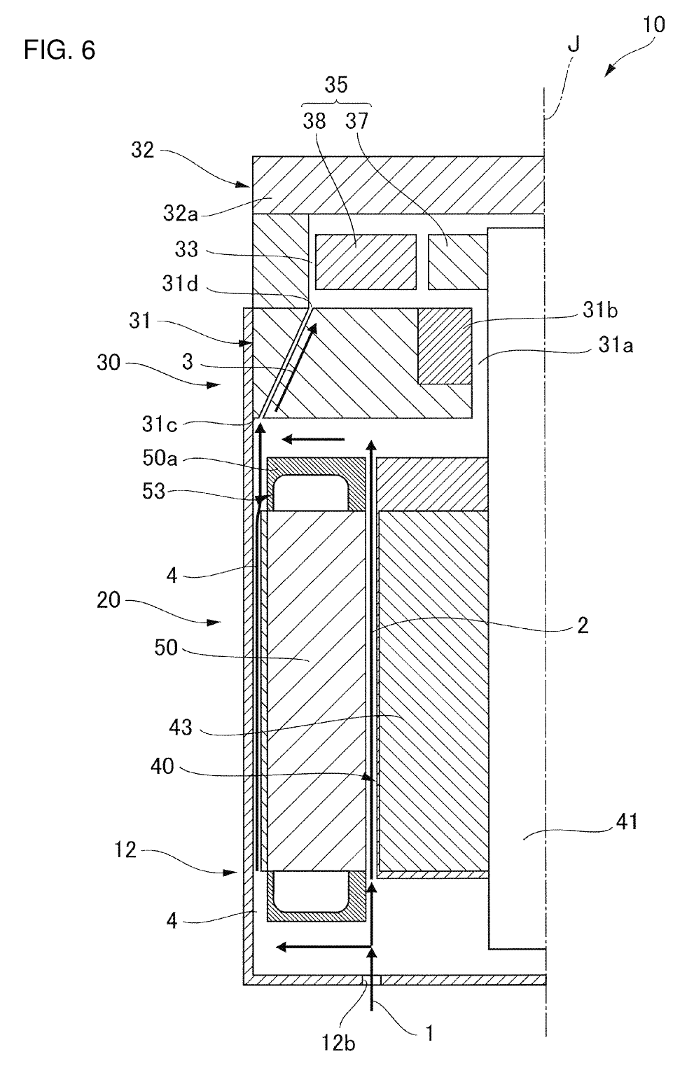

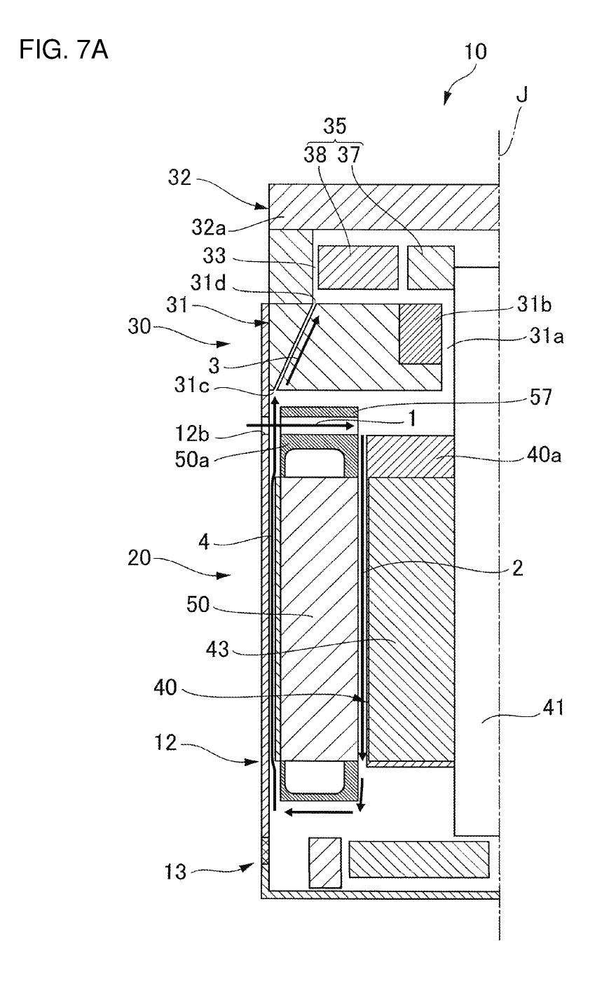

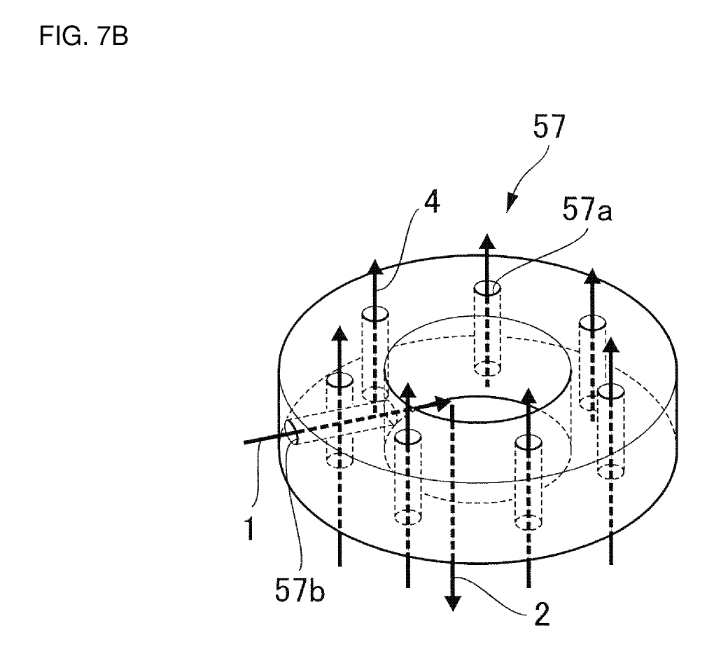

In FIG. 3, the passage 1 (the first passage) is connected from the intake opening 12b of the housing 12 to the inside of the motor unit 20 and is located between the rear side end portion of the stator 50 and the front side end portion of the control device 70 and the bus bar assembly 60. Furthermore, the first passage 1 becomes different in accordance with the position of the intake opening 12b. The position of the intake opening 12b is not limited to a position shown in FIGS. 1 and 3 and may be provided at an arbitrary position of the side surface of the housing 12 and the bottom portion (the cover 13) of the housing as described above. An example in which the intake opening 12b is provided at the other positions will be described with reference to FIGS. 6 and 7.

### Second Passage

The second passage 2 of FIG. 3 is provided between the stator 50 and the rotor 40. In the example shown in FIG. 3, the second passage 2 is located between the inner peripheral surface of the stator 50 and the outer peripheral surface of the rotor 40. Oil flowing into the first passage 1 flows from one end at the rear side of the second passage 2 to one at the front side.

Furthermore, the position of the second passage 2 is not limited to a position between the inner peripheral surface of the stator 50 and the outer peripheral surface of the rotor 40. For example, as shown in FIG. 4, a through-hole 52b or a notch portion 51a may be provided in the core back portion 51 of the stator 50 and the through-hole 52b or the notch portion 51a may be used as the second passage 2. A gap between the plurality of tooth portions 52 which are included in the core back portion 51 and are separated from each other (a gap between the adjacent teeth) may be used as the second passage 2. When the through-hole 52b or the notch portion 51a of the core back portion 51 or the gap between the adjacent tooth portions 52 is used as the oil passage, it is possible to more efficiently cool the coil 53 of the stator 50 and to cool the rotor 40.

Similarly to the stator 50, the rotor core 43 may be provided with a through-hole (not shown) or a notch portion (not shown) and the through-hole or the notch portion may be used as the second passage 2. When the through-hole or the notch portion of the rotor core 43 is used as a passage, it is possible to more efficiently cool the rotor 40 and to prevent the demagnetization of the rotor magnet 44. That is, the second passage 2 may be provided at an arbitrary position as long as the position is between the stator 50 and the rotor 40.

### Third Passage

The third passage 3 of FIG. 3 is provided in the pump body 31 and connects the second passage 2 to the inside of the pump unit 30. Specifically, the third passage 3 includes a first opening portion 31c which is provided at the rear side end portion of the pump body 31 and includes a second opening portion 31d which is provided in the vicinity of the negative pressure region of the pump chamber 33. Since the third passage 3 is provided, oil which is sucked into the motor unit 20 through the intake opening 12b can circulate from the inside of the motor unit 20 to the inside of the pump unit 30. Accordingly, it is possible to efficiently cool the stator 50 and the rotor 40. Furthermore, the position of the first opening portion 31c is not limited to a position shown in FIG. 3 and may be provided at an arbitrary position as long as the position is the rear side end portion of the pump body 31.

The cross-sectional area of the first opening portion 31c which is the rear side opening portion of the third passage is smaller than the cross-sectional area of the discharge opening 32d of the pump unit 30. Thus, since the amount of the oil flowing from the inside of the motor unit 20 to the inside of the pump unit 30 becomes smaller than the discharge amount of the pump, it is possible to prevent an excessive amount of oil from flowing into the negative pressure region. Also, it is possible to prevent a decrease in pump efficiency due to the excessive amount of oil flowing into the negative pressure region.

In this example embodiment, the stator 50 is molded by resin. That is, the stator 50 is an integrally molded product formed by resin 50a. In a case in which the stator 50 is an integrally molded product formed of resin, it is possible to increase a surface area in which the stator 50 contacts oil in the second passage 2 and a fourth passage 4 to be described later. For this reason, it is possible to more efficiently cool the inside of the motor unit 20.

Similarly to the stator 50, the rotor 40 may be molded by resin. That is, the rotor 40 may be an integrally molded product formed of resin. When the rotor 40 is molded, since it is possible to increase a surface area in which the rotor 40 contacts the oil in the second passage 2, it is possible to prevent the demagnetization of the rotor magnet 44 and to more efficiently cool the motor.

According to this example embodiment, the pump device 10 includes the shaft 41 which rotates about the center axis extending in the axial direction, the motor unit 20 which rotates the shaft 41, and the pump unit 30 which is located at one side of the axial direction of the motor unit 20 and is driven by the motor unit 20 through the shaft 41 so that oil is discharged. The motor unit 20 includes the rotor 40 which rotates about the shaft 41, the stator 50 which is disposed to face the rotor 40, the housing 12 which accommodates the rotor 40 and the stator 50, and the intake opening 12b which is provided in the housing 12 to suck oil. The pump unit 30 includes the pump rotor 35 which is attached to the shaft 41, the pump casing (31 and 32) which accommodates the pump rotor 35, and the discharge opening 32d which is provided in the pump casing (31 and 32) and discharges oil. The pump device 10 includes the first passage 1 which sucks oil from the intake opening 12b of the motor unit 20, the second passage 2 which is provided between the stator 50 and the rotor 40, and the third passage 3 which is connected from the second passage 2 to the negative pressure region inside the pump unit 30 and the pump unit 30 discharges oil flowing from the third passage 3 to the pump unit 30 from the discharge opening 32d.

According to this example embodiment, the oil which is discharged from the discharge opening 32d by the pump rotor 35 and passes through the external device circulates inside the motor unit 20 through the intake opening 12b of the motor unit 20 to simultaneously cool the stator 50 and the rotor 40. The oil circulating in the motor unit 20 is returned to the pump chamber 33 and the pump rotor 35 discharges the oil returned from the motor unit 20 from the discharge opening 32d. Thus, since it is possible to circulate the oil from the pump unit 30 to the motor unit 20 by a series of passages, it is possible to circulate the oil inside the motor unit 20 to simultaneously cool the stator 50 and the rotor 40 without decreasing the pump efficiency.

### Fourth Passage

As the other passages, the pump device 10 may include the fourth passage 4 in addition to the first passage to the third passage. The fourth passage 4 is a passage which is provided at the inside of the radial direction or the outside of the radial direction of the stator 50 and the rotor 40. Since the fourth passage is provided, it is possible to more efficiently circulate the oil between the pump unit 30 and the motor unit 20 and to highly efficiently cool the motor unit 20.

The fourth passage 4 is provided at the outside of the radial direction or the inside of the radial direction of the stator 50 and the rotor 40. The fourth passage 4 shown in FIG. 3 corresponds to an example in which the passage is provided at the outside of the radial direction of the stator 50 and the rotor 40. Specifically, the fourth passage 4 is provided between the outer peripheral surface of the stator 50 and the inner peripheral surface of the housing 12. Furthermore, an example in which the fourth passage 4 is provided at the inside of the radial direction of the stator 50 and the rotor 40 will be described later.

The fourth passage 4 is joined to the second passage 2 at the front side and is connected to the third passage 3. Oil flowing into the first passage 1 branches to oil flowing into the second passage 2 and oil flowing into the fourth passage 4. The oil flowing into the fourth passage 4 flows from one end at the rear side of the fourth passage 4 to one end at the front side thereof. Then, the oil flowing to the front side merges with the oil flowing from the second passage 2 and flows to the third passage 3. Since it is possible to increase a surface area in which the stator 50 contacts the oil by providing the fourth passage 4, it is possible to more efficiently cool the inside of the motor unit 20. In general, the coil generates most heat in the motor. Heat generated by the coil is transmitted to the core back portion 51 and the tooth portions 52. That is, the heat generation amount of the stator 50 in the motor unit 20 is large. Thus, it is possible to efficiently cool the motor unit 20 when the stator 50 can be efficiently cooled.

The fourth passage 4 may include, as shown in FIG. 4, the notch portion 51a in the outer peripheral surface of the core back portion 51. Further, the fourth passage 4 may include the notch portion 12a in the inner peripheral surface of the housing 12. The fourth passage 4 may include both of the notch portion 51a and the notch portion 12a or any one of them. Furthermore, a position in which the notch portion is provided in the stator 50 is not limited to the outer peripheral surface and may be, for example, the inner peripheral surface.

Since the surface area in which the stator 50 contacts the oil can be increased when the stator 50 includes the notch portion 51a, it is possible to more efficiently cool the inside of the motor unit 20. Further, since it is possible to increase the amount of oil flowing into the fourth passage 4 when the stator 50 includes the notch portion 51a or the housing 12 includes the notch portion 12a, it is possible to more efficiently circulate the oil.

Furthermore, the position of the fourth passage 4 is not limited to a position between the outer peripheral surface of the stator 50 and the inner peripheral surface of the housing 12. For example, as shown in FIG. 4, the through-hole 52b may be provided in the core back portion 51 of the stator 50 and the through-hole 52b may be used as the fourth passage 4. Further, a gap between the tooth portions 52 disposed such that the plurality of tooth portions 52 of the core back portion 51 are separated from each other may be used as the fourth passage 4.

Furthermore, in a case in which a gap between the adjacent tooth portions 52 is used as the fourth passage 4, a ring member 56 (a first ring member) may be provided between the stator 50 and the rotor 40 as shown in FIG. 4. Since the oil flowing between the tooth portions 52 corresponding to the fourth passage 4 does not merge with the oil flowing between the rotor 40 and the stator 50 corresponding to the second passage 2 when the ring member 56 is used, the oil can be efficiently circulated inside the motor unit 20.

Since the through-hole 52b or the notch portion 52b of the core back portion 51 or a gap between the adjacent tooth portions 52 is used as the oil passage, it is possible to more efficiently cool the coil 53 of the stator 50 and to cool the rotor 40.

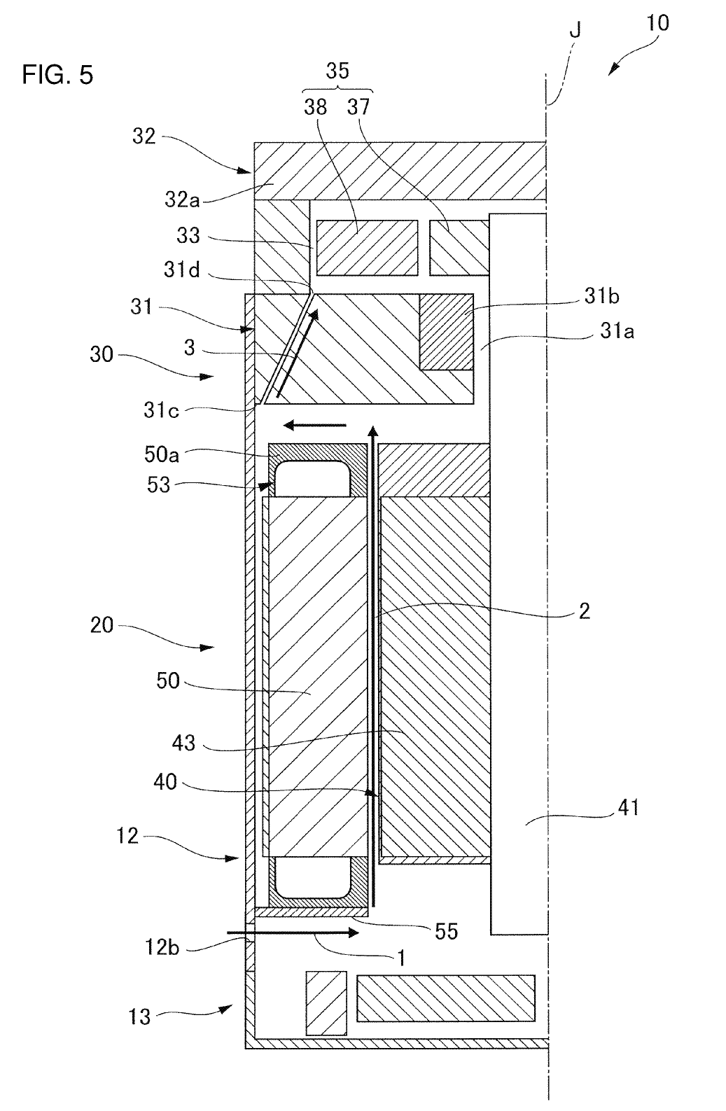

Furthermore, since the oil of the first passage 1 does not branch to the fourth passage 4 but flows to the second passage 2, a cover member 55 shown in FIG. 5 may be used. The cover member 55 is an annular member that covers a gap between the side surface of the housing 12 and the rear side end portion of the stator 50. Furthermore, the cover member 55 may cover a gap between the side surface of the housing 12 and the rear side end portion of the stator 50 and may not cover the entire rear side end portion of the stator 50 as shown in FIG. 5.

Since the oil flowing from the intake opening 12b into the first passage 1 flows to the second passage along the cover member 55 when the cover member 55 is provided, the oil can efficiently flow to the second passage. Thus, it is possible to more efficiently cool the stator 50 and the rotor 40 at the same time. The second passage 2 and the third passage 3 are the same as those of FIG. 3.

### First Modified Example of Intake Opening

In the example shown in FIG. 3, the intake opening 12b is provided in the cylindrical portion 14 of the housing 12 (the side surface of the housing) to be located between the rear side end portion of the stator 50 and the rear side end portion (the bottom portion) of the housing 12. However, the position of the intake opening 12b is not limited thereto and the intake opening may be provided at an arbitrary position of the housing 12 or may be provided in the cover 13. As a modified example of the intake opening, a case in which the intake opening 12b is provided in the bottom portion of the housing 12 will be described below.

FIG. 6 is a diagram showing a case in which the intake opening 12b is provided in the bottom portion of the housing 12.

In FIG. 6, the control device 70 and the bus bar assembly are attached to the side surface of the motor unit 20 differently from the example shown in FIG. 1. Further, in FIG. 6, the lid portion 22b of the cover 13 is set as the bottom portion of the housing and the cylindrical portion 22a of the cover 13 is included in the side surface of the housing.

The passage 1 (the first passage) of FIG. 6 is a passage which is connected from the intake opening 12b provided in the bottom portion of the housing 12 to the second passage. Oil flowing into the first passage branches to the second passage and the fourth passage. The second passage to the fourth passage are the same as those of FIG. 3. In this way, the intake opening 12b can be also provided in the bottom portion of the housing 12.

### Second Modified Example of Intake Opening

FIG. 7 is a diagram showing a case in which the intake opening 12b is provided in the cylindrical portion 14 of the housing 12 (the side surface of the housing) to be located between the front side end portion of the stator 50 and the rear side end portion of the pump body 31. In this example embodiment, the motor unit 20 includes a ring member (a second ring member) 57. The ring member 57 is fitted between the pump unit 30 and the stator 50 as shown in FIG. 7A. The ring member 57 includes, as shown in FIG. 7B, a first through-hole 57a which is formed in the axial direction by penetration and a second through-hole 57b which is formed in the radial direction by penetration. The first through-hole is provided at one or a plurality of positions.

The ring member 57 is disposed to be connected to the intake opening 12b. Specifically, the ring member 57 is disposed so that the intake opening 12b is connected to the second through-hole 57b. As shown in FIGS. 7A and 7B, a conduction portion connected from the intake opening 12b to the second through-hole is used as the passage 1 (the first passage). The second passage is provided between the stator 50 and the rotor 40 similarly to FIG. 3, but in this example embodiment, the oil flowing from the passage 1 (the first conduction portion) flows from the front side end portion of the second passage to the rear side end portion thereof.

Similarly to FIG. 3, the fourth passage is provided between the stator 50 and the housing 12, but is connected to the third passage through the first through-hole 57a. That is, the oil flowing to the third passage flows to the third passage through the first through-hole 57a when reaching the ring member 57. In this way, the intake opening 12b can be provided in the cylindrical portion 14 of the housing 12 (the side surface of the housing) to be located between the front side end portion of the stator 50 and the rear side end portion of the pump body 31. Since the first passage does not overlap the fourth passage when the ring member 57 is provided, it is possible to efficiently circulate the oil inside the motor unit 20 without branching the oil.

As the other passages, the pump device 10 may further include, for example, a passage which is provided between the outer peripheral surface of the shaft 41 and the inner peripheral surface of the rotor 40. Further, for example, the rotor 40 may be provided with a through-hole (not shown) and the through-hole may be used as a passage. Since the other passages are provided in addition to the first passage 1 to the fourth passage 4, it is possible to more efficiently circulate the oil between the pump unit 30 and the motor unit 20 and to highly efficiently cool the motor unit 20.

### Second Example Embodiment

Next, a pump device according to a second example embodiment of the disclosure will be described. In the first example embodiment, the motor unit is configured as an inner rotor type motor in which the stator is located at the outside of the rotor in the radial direction. In contrast, the motor unit of this example embodiment is configured as an axial gap type motor in which the stator is disposed to face the rotor in the axial direction. Hereinafter, a difference from the first example embodiment will be chiefly described. In the pump device according to this example embodiment, the same reference numerals will be given to the same components as those of the pump device according to the first example embodiment and a description thereof will be omitted.

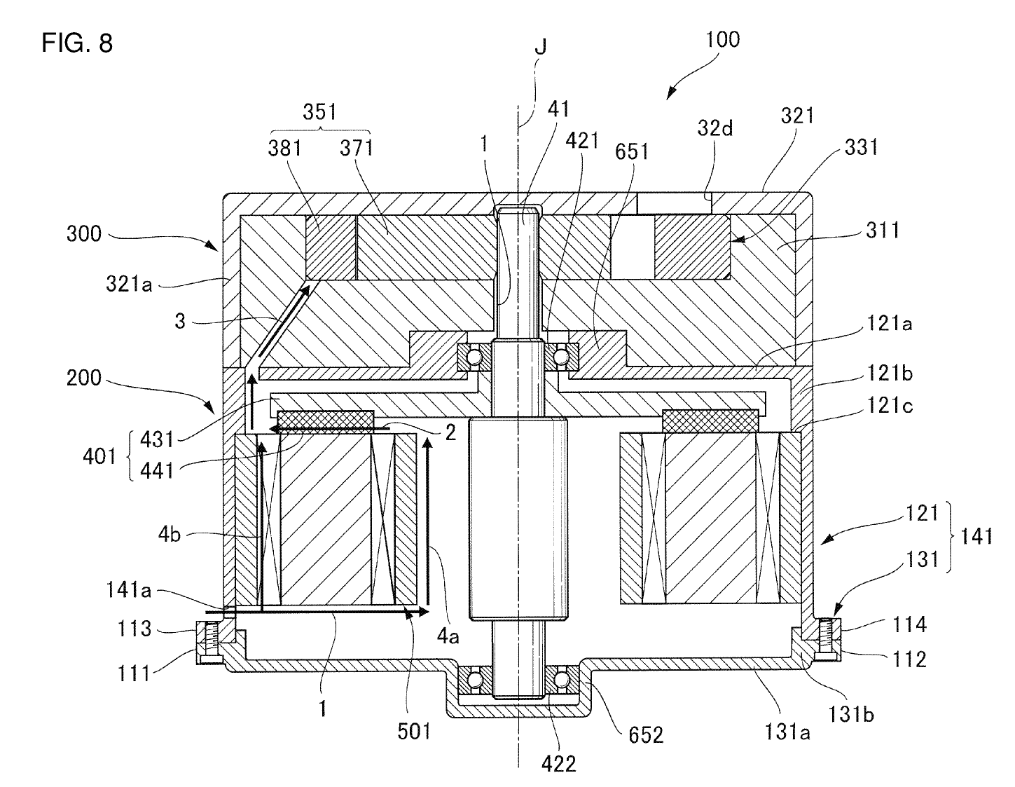

FIG. 8 is a cross-sectional view showing a pump device 100 of this example embodiment.

The pump device 100 includes, as shown in FIG. 8, a shaft 41, a motor unit 200, a housing 141, and a pump unit 300. The shaft 41 rotates about a center axis J extending in the axial direction. The motor unit 200 and the pump unit 300 are arranged side by side in the axial direction.

The motor unit 200 includes a rotor 401, a stator 501, an upper bearing member 421, a lower bearing member 422, a bus bar assembly (not shown), and a connector (not shown). The rotor 401 has a disk shape which extends in the radial direction. The rotor 401 includes a plurality of magnets 441 which are arranged in the circumferential direction of a surface (the −Z side surface) facing the stator 501 and a rotor yoke 431 which holds the magnets 441. That is, the magnet 441 is disposed to face the front side end portion of the stator 501 in the axial direction. The rotor yoke 431 is fixed to the outer peripheral surface of the shaft 41.

An upper bearing member 421 and a lower bearing member 422 support the shaft 41 to be rotatable. The upper bearing member 421 is fixed to a housing 141. Furthermore, the lower bearing member 422 may not be provided and the housing 141 may have a sliding bearing structure (a bearing member). When an intake opening 141a is provided in a bottom portion (131a) of the housing 141 and is located between the bearing member and the shaft 41, the oil which is sucked from the intake opening 141a in the first passage 1 can be used as lubricating oil and the oil can be efficiently sucked into the motor unit 200.

The stator 501 includes a plurality of cores which have a fan shape in the plan view and are arranged in the circumferential direction, a coil which is provided in each core, a coil drawn wire which is drawn from the coil of each core, a mold resin which integrally fixes the plurality of cores, and a drawn wire support portion which is provided at the outer peripheral end of the stator 501.

The housing 141 constitutes the casing of the motor unit 200. The stator 501 is held at the substantially center portion of the housing 141 in the axial direction. Furthermore, a control device and a bus bar assembly (not shown) may be accommodated at the rear side (−Z side) of the stator. The rotor 401 is accommodated at the front side (+Z side) of the stator 501. The housing 141 includes a first housing 121 which has a bottomed cylindrical shape of which the rear side opens and a second housing (a cover) 131 which has a bottomed cylindrical shape and is connected to the rear side (−Z side) of the first housing 121. The material of the housing 141 is, for example, metal or resin.

A stepped portion 121c is formed in an inner peripheral surface of a cylindrical portion 121b of the first housing 121. The stator 501 is held by the stepped portion 121c. The first housing 121 includes a disk-shaped top wall 121a and an upper bearing holding portion 651 which is provided at the center portion of the top wall 121a. The upper bearing holding portion 651 is fitted to the rear side opening portion of the pump unit 300. The upper bearing holding portion 651 holds the upper bearing member 421.

The second housing 131 includes a disk-shaped bottom wall 131a, a cover cylindrical portion 131b which extends from the peripheral edge portion of the bottom wall 131a to the front side (+Z side), and a lower bearing holding portion 652 which is provided at the center portion of the bottom wall 131a. The cover cylindrical portion 131b is fixed to the opening portion at the rear side (−Z side) of the first housing 121. More specifically, the first housing 121 and the second housing 131 are fixed to each other by a method such as bolt fastening using the flange portions 111 and 112 of the second housing 131 and the flange portions 113 and 114 of the first housing 121.

When a control device (not shown) and a bus bar assembly (not shown) are accommodated in the second housing 131, the bottom wall 131a of the second housing 131 is provided with a through-hole (not shown) which penetrates the bottom wall 131a in the axial direction and a connector (not shown) is attached to the through-hole. An external connection terminal (not shown) which penetrates the bottom wall 131a from the bus bar assembly and extends to the rear side (−Z side) is disposed in the connector.

The housing 141 includes the intake opening 141a. The intake opening 141a sucks oil discharged from the discharge opening 32d by the pump unit 300. In the example shown in FIG. 8, the intake opening 141a is provided in the cylindrical portion 121b (the side surface of the housing). Specifically, the intake opening 141a is provided in the cylindrical portion 121b of the first housing 121 (the side surface of the housing) and is located between the bottom portion of the housing 141 (the bottom wall 131a of the second housing 131) and one end of the stator 501 (the rear side end portion of the stator 501) opposite to the pump unit 300 in the axial direction.

Since the intake opening 141a is provided at the above-described position, oil can smoothly flow through a second passage inside the motor unit 200 to be described later. That is, since an optimal passage can be provided, it is possible to efficiently spread oil throughout the stator 501. For this reason, the stator 501 can be efficiently cooled.

Furthermore, the position of the intake opening 141a is not limited thereto. The intake opening 141a may be provided at an arbitrary position of the housing 141. For example, the intake opening 141a may be provided at the bottom wall 131a of the second housing 131 (the bottom portion of the housing 141). The first passage 1 to the fourth passage 4 when the intake opening 141a is provided in the bottom portion of the housing 141 are the same as those of the first example embodiment (FIG. 6). The position of the intake opening 141a may be determined in response to a position of an external device to which the pump device 100 is attached similarly to the first example embodiment. Similarly to the first example embodiment, the number of the intake openings 141a is not limited to one but may be plural.

The pump unit 300 is located at one side, specifically, the front side (+Z side) of the motor unit 200 in the axial direction. The pump unit 300 is driven by the motor unit 200 through the shaft 41. The pump unit 300 includes a pump body 311, a pump rotor 351, and a pump cover 321. The pump rotor 351 includes an inner rotor 371 and an outer rotor 381.

The pump cover 321 includes a discharge opening 32d. Similarly to the first example embodiment, the pump unit 300 is a displacement type pump and is a trochoid pump in this example embodiment. Furthermore, the pump unit 300 is not limited to the trochoid pump and may be other types of pumps as long as the pump is a displacement type pump. Since each member of the pump unit 300 is the same as that of the first example embodiment, a description thereof will be omitted.

Next, a cooling structure of the pump device 100 according to this example embodiment will be described. According to this example embodiment, similarly to the first example embodiment, oil supplied to a pump chamber 331 is discharged from the discharge opening 32d by the pump rotor 351, passes through an external device, and circulates inside the motor unit 200 through the intake opening 141a of the motor unit 200 to simultaneously cool the stator 501 and the rotor 401.

Oil circulating in the motor unit 200 is returned to the pump chamber 331 and the pump rotor 351 discharges the oil returned from the motor unit 200 from the discharge opening 32d. According to this example embodiment, since it is possible to circulate the oil from the pump unit to the motor unit by a series of the passages, it is possible to simultaneously cool the stator and the rotor without decreasing the pump efficiency. Hereinafter, the oil passage of the pump device 100 will be described by focusing on a difference from the first example embodiment.

The pump device 100 includes, as shown in FIG. 8, a passage 1 (a first passage) which sucks oil from the intake opening 141a of the motor unit 200, a passage 2 (a second passage) which is provided between the stator 501 and the rotor 401, and a passage 3 (a third passage) which is connected from the second passage to a negative pressure region inside the pump unit 300. The pump unit 300 discharges oil flowing from the third passage to the pump unit 300 (the pump chamber 331) from the discharge opening 32d.

Since the first passage and the third passage of this example embodiment are the same as those of the first example embodiment, a description thereof will be omitted. In this example embodiment, the second passage is located between the rotor 401 and one end of the stator 501 in the axial direction facing the magnet 441 of the rotor 401 as shown in FIG. 8.

Also in this example embodiment, similarly to the first example embodiment, the stator 501 and the rotor 401 may be an integrally molded product which is formed of resin. When the stator 501 or the rotor 401 is an integrally molded product formed of resin, it is possible to increase a surface area in which the stator 50 and the rotor 401 contact the oil. For this reason, it is possible to more efficiently cool the inside of the motor unit 20. It is possible to prevent the demagnetization of the rotor magnet 44 by increasing the surface area in which the rotor 401 contacts the oil.

According to this example embodiment, the pump device 100 includes the shaft 41 which rotates about the center axis extending in the axial direction, the motor unit 200 which rotates the shaft 41, and the pump unit 300 which is located at one side of the motor unit 200 in the axial direction and is driven by the motor unit 200 through the shaft 41 to discharge oil. The motor unit 200 includes the rotor 401 which rotates about the shaft 41, the stator 501 which is disposed to face the rotor 401, the housing 141 which accommodates the rotor 401 and the stator 501, and the intake opening 141a which is provided in the housing 141 to suck oil. The pump unit 300 includes the pump rotor 351 which is attached to the shaft 41, the pump casing (311 and 321) which accommodates the pump rotor 351, and the discharge opening 32d which is provided in the pump casing (311 and 321) to discharge oil. The pump device 100 includes the first passage which sucks oil from the intake opening 141a of the motor unit 200, the second passage which is provided between the stator 501 and the rotor 401, and the third passage which is connected from the second passage to the negative pressure region inside the pump unit 300 and the pump unit 300 discharges oil flowing from the third passage to the pump unit 300 from the discharge opening 32d.

According to this example embodiment, the oil which is discharged from the discharge opening 32d by the pump rotor 351 and passes through an external device circulates inside the motor unit 200 through the intake opening 141a of the motor unit 200 to simultaneously cool the stator 501 and the rotor 401. The oil circulating in the motor unit 200 is returned to the pump chamber 331 and the pump rotor 351 discharges the oil returned from the motor unit 200 from the discharge opening 32d. Thus, since it is possible to circulate the oil from the pump unit to the motor unit by a series of passages, it is possible to circulate the oil inside the motor to simultaneously cool the stator and the rotor without decreasing the pump efficiency.

Furthermore, also in this example embodiment, a fourth passage may be provided as the other passages in addition to the first passage to the third passage. In this example embodiment, the fourth passage includes two passages as below as shown in FIG. 8. A first passage 4a is located between the stator 501 and the shaft 41, that is, the inside of the stator 501 and the rotor 401 in the radial direction. A second passage 4b is located between the stator 501 and the housing 141 which holds the stator 501.

That is, the passage 4b is located at the outside of the stator 501 and the rotor 401 in the radial direction. Thus, in this example embodiment, the fourth passage is provided at the inside of the stator 501 and the rotor 401 in the radial direction and the outside of the stator 501 and the rotor 401 in the radial direction. The fourth passage is joined to the second passage at the front side to be connected to the third passage. Also in this example embodiment, since the fourth passage is provided, it is possible to increase a surface area in which the stator 501 and the rotor 401 contact the oil similarly to the first example embodiment. For this reason, the pump device 100 is able to more efficiently cool the motor unit 200.

Similarly to the first example embodiment, the fourth passage (the passage 4a or 4b) may include a notch portion (not shown) formed in the outer peripheral surface or the inner peripheral surface of the stator 501. Further, the fourth passage (the passage 4a or 4b) may include a notch portion (not shown) formed in the inner peripheral surface of the housing 141 or the outer peripheral surface of the shaft. Since it is possible to increase a surface area in which the stator 501 contacts the oil when the stator 501 includes the notch portion, it is possible to more efficiently cool the inside of the motor unit 200. Further, since it is possible to increase the amount of the oil flowing into the fourth passage when the stator 501, the housing 141, or the shaft 41 includes the notch portion, it is possible to more efficiently circulate the oil.

Furthermore, the position of the fourth passage (the passage 4a or 4b) is not limited to a position between the outer peripheral surface of the stator 501 and the inner peripheral surface of the housing 141 or a position between the inner peripheral surface of the stator 501 and the outer peripheral surface of the shaft 41. For example, similarly to the first example embodiment, a through-hole may be provided in a core back portion (not shown) of the stator 50 and the through-hole 52b may be used as a fourth passage.

Furthermore, since the oil of the first passage does not branch to the fourth passage (the passage 4b) but flows to the second passage, the cover member may be used similarly to the first example embodiment (FIG. 5). The cover member may cover the rear side end portion of the fourth passage (the passage 4b). Since the oil flowing to the first passage flows to the second passage without any branching by the cover member, the oil can efficiently flow to the second passage. Thus, it is possible to more efficiently cool the stator 50 and the rotor 40.

Further, in the pump device 100 of this example embodiment, a case in which the stator 501 is fixed to the cylindrical portion 121b of the housing 141 has been described, but the disclosure is not limited thereto. The disclosure can be also applied to a case in which the stator 501 of the pump device 100 is fixed to the shaft 41 and the pump device 100 has a cooling structure using the same passages.

Further, in this example embodiment, a case in which the motor unit 200 of the pump device 100 includes only the rotor 401 has been described, but the disclosure is not limited thereto. For example, the motor unit 200 may include two rotors, two rotors may be attached to the shaft 41 with a predetermined gap formed therebetween in the axial direction, and the stator 501 may be disposed between two rotors. The disclosure can be also applied to a configuration including the two rotors.

### Third Example Embodiment

Next, a pump device according to a third example embodiment of the disclosure will be described. In the first example embodiment, the motor unit 20 of the pump device 10 is configured as an inner rotor type motor, and in the second example embodiment, the motor unit 200 of the pump device 100 is configured as an axial gap type motor. In contrast, the motor unit of this example embodiment is configured as an outer rotor type motor in which the stator is located at the inside of the rotor in the radial direction. Hereinafter, a difference between the first example embodiment and the second example embodiment will be mainly described. In the pump device according to this example embodiment, the same reference numerals will be given to the same configurations as those of the pump device according to the first example embodiment or the second example embodiment and a description thereof will be omitted.

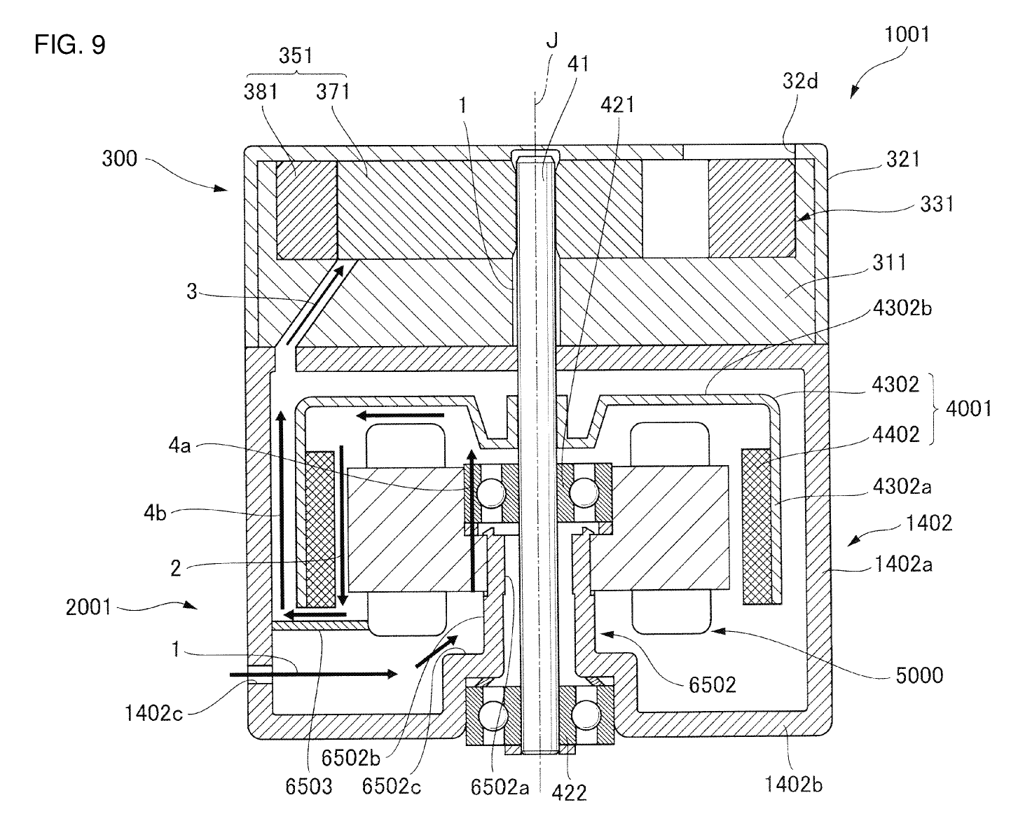

FIG. 9 is a cross-sectional view of a pump device 1001 according to this example embodiment.

The pump device 1001 includes a shaft 41, a motor unit 2001, and a pump unit 300. The shaft 41 rotates about a center axis J extending in the axial direction. The motor unit 2001 and the pump unit 300 are arranged side by side in the axial direction.

The motor unit 2001 includes, as shown in FIG. 9, a housing 1402, a rotor 4001, a stator 5000, a bearing housing 6502, an upper bearing member 421, a lower bearing member 422, a control device (not shown), and a bus bar assembly (not shown). Furthermore, the control device and the bus bar assembly may not be provided inside the motor unit 2001, but may be attached to, for example, one end of the housing 1402 at the rear side in the axial direction or the side surface of the housing 1402.

The rotor 4001 includes a rotor magnet 4402 and a rotor yoke 4302. The rotor yoke 4302 has a cup shape which opens to the rear side. The rotor yoke includes a disk-shaped ceiling plate portion 4302b in which the shaft 41 is connected to the center and a cylindrical portion 4302a which is provided so that the outer periphery of the ceiling plate portion 4302b extends to the rear side. The rotor magnet 4402 is disposed in the inner peripheral surface of the cylindrical portion 4302a of the rotor yoke 4302 and the inner peripheral surface faces the stator 5000 in the radial direction. The rotor 4001 is fixed to the shaft 41.

The bearing housing 6502 includes a bearing housing cylindrical portion 6502b which has a cylindrical shape, an annular protrusion portion 6502a which is provided in the inner peripheral surface of the bearing housing cylindrical portion 6502b, and a flange portion 6502c which is provided in the outer peripheral surface of the bearing housing cylindrical portion 6502b. The annular protrusion portion 6502a protrudes inward so that the inner diameter of the bearing housing cylindrical portion 6502b decreases.

The lower bearing member 422 is provided at the rear side in the inner peripheral surface of the bearing housing cylindrical portion 6502b. The upper bearing member 421 is provided at the front side in the inner peripheral surface of the bearing housing cylindrical portion 6502b. Each of the upper bearing member 421 and the lower bearing member 422 is fitted to the shaft 41. The upper bearing member 421 and the lower bearing member 422 support the shaft 41 to be rotatable with respect to the bearing housing 6502.

Furthermore, the lower bearing member 422 may not be provided and the housing 1402 may have a sliding bearing structure (a bearing member). When an intake opening 1402c is provided in the bottom portion (1402b) of the housing 1402 and is located between the bearing member (the sliding bearing structure) and the shaft 41, the oil which is sucked from the intake opening 1402c in the first passage 1 can be used as lubricating oil and the oil can be efficiently sucked into the motor unit 2001.

The stator 5000 is fixed to the outer periphery of the bearing housing 6502. Specifically, the bearing housing 6502 is fitted to the inner peripheral surface of the annular core back of the stator 5000. A bottom wall 1402b of the housing 1402 is disposed at the rear side of the stator 5000 and supports the bearing housing 6502. The control device (not shown) is disposed between the stator 5000 and the bottom wall 1402b of the housing 1402.

The housing 1402 includes the intake opening 1402c. The intake opening 1402c sucks oil discharged from the discharge opening 32d by the pump unit 300. In the example shown in FIG. 9, the intake opening 1402c is provided in a cylindrical portion 1402a (the side surface of the housing). Specifically, the intake opening 1402c is provided in the cylindrical portion 1402a of the housing 1402 (the side surface of the housing) and is located between the rear side end portion (the bottom portion) of the housing 1402 and one end of the stator (the rear side end portion of the stator 5000) opposite to the pump unit in the axial direction.

Since the intake opening 1402c is provided at the above-described position, oil can smoothly flow through a second passage inside the motor unit 2001 to be described later. That is, since an optimal passage can be provided, it is possible to efficiently spread oil throughout the stator 5000. For this reason, the stator 5000 can be efficiently cooled.

Furthermore, the position of the intake opening 1402c is not limited thereto. The intake opening 1402c may be provided at an arbitrary position of the housing 1402. For example, the intake opening 1402c may be provided at the bottom wall 1402b of the housing (the bottom portion of the housing 1402). Even when the intake opening 1402c is provided in the bottom portion of the housing 1402, the second passage to the fourth passage are the same as those of a case in which the intake opening 1402c is provided in the side surface of the housing 1402.

Furthermore, when the intake opening 1402c is provided in the bottom portion of the housing 1402 and is located between the bearing housing 6502 and the shaft 41, the fourth passage to be described later passes through any one of a gap formed between the lower bearing member 422 and the bearing housing 6502, a gap formed between the lower bearing member 422 and the shaft 41, and the inside of the lower bearing member 422. The outer peripheral surface of the shaft 41 may have a notch portion. Then, when the fourth passage passes through a part of a gap formed between the lower bearing member 422 and the shaft 41, it is possible to increase the amount of the oil flowing into the fourth passage by the notch portion. The position of the intake opening 141a may be determined in response to a position of an external device to which the pump device 100 is attached similarly to the first example embodiment.

The number of the intake openings 1402c is not limited to one but may be plural. Since the intake opening 1402c is provided at a plurality of positions, it is possible to flow (suck) more oil into the motor unit 2001. For this reason, even when the oil discharge amount from the pump is large, it is possible to secure an optimal oil suction amount inside the motor. Since an optimal oil suction amount is secured, it is possible to optimally cool the stator and the rotor in the cooling structure to be described later. Since the configuration of the pump unit 300 is the same as that of the first example embodiment, a description thereof will be omitted.

Next, a cooling structure of the pump device 1001 according to this example embodiment will be described. According to this example embodiment, similarly to the first example embodiment and the second example embodiment, the oil supplied to the pump chamber 331 is discharged from the discharge opening 32d by the pump rotor 351, passes through the external device, and circulates inside the motor unit 2001 through the intake opening 1402c of the motor unit 2001 so that the stator 5000 and the rotor 4001 are cooled at the same time.

The oil which circulates in the motor unit 2001 is returned to the pump chamber 331 and the pump rotor 351 discharges the oil returned from the motor unit 2001 from the discharge opening 32d. According to this example embodiment, since it is possible to circulate the oil from the pump unit to the motor unit by a series of passages, it is possible to simultaneously cool the stator and the rotor without decreasing the pump efficiency. Hereinafter, the oil passage of the pump device 1001 will be described by focusing on a difference from the first example embodiment and the second example embodiment.

The pump device 1001 includes, as shown in FIG. 9, a passage 1 (a first passage) which sucks oil from the intake opening 1402c of the motor unit 2001, a passage 2 (a second passage) which is provided between the stator 5000 and the rotor 4001, and a passage 3 (a third passage) which is connected from the second passage to the negative pressure region inside the pump unit 300. The pump unit 300 discharges the oil flowing from the third passage to the pump unit 300 (the pump chamber 331) from the discharge opening 32d.

In this example embodiment, a ring member 6503 is provided to connect the rear side end portion of the stator 5000 to the side surface (1402a) of the housing 1402. Accordingly, since a passage through which oil flows to the fourth passage is divided from the first passage and the second passage, the oil efficiently flows inside the motor unit 2001.

Also in this example embodiment, similarly to the first example embodiment and the second example embodiment, the stator 5000 and the rotor 4001 may be an integrally molded product which is formed of resin. When the stator 5000 or the rotor 4001 is an integrally molded product which is formed of resin, it is possible to increase a surface area in which the stator 5000 and the rotor 4001 contact the oil. For this reason, it is possible to more efficiently cool the inside of the motor unit 2001. Since the surface area in which the rotor 4001 contacts the oil increases, it is possible to prevent the demagnetization of the rotor magnet 4402.

According to this example embodiment, the pump device 1001 includes the shaft 41 which rotates about the center axis extending in the axial direction, the motor unit 2001 which rotates the shaft 41, and the pump unit 300 which is located at one side of the motor unit 2001 in the axial direction and is driven by the motor unit 2001 through the shaft 41 so that the oil is discharged. The motor unit 2001 includes the rotor 4001 which rotates about the shaft 41, the stator 5000 which is disposed to face the rotor 4001, the housing 1402 which accommodates the rotor 4001 and the stator 5000, and the intake opening 1402c which is provided in the housing 1402 to suck oil. The pump unit 300 includes the pump rotor 351 which is attached to the shaft 41, the pump casing (311 and 321) which accommodates the pump rotor 351, and the discharge opening 32d which is provided in the pump casing (311 and 321) to discharge oil. The pump device 1001 includes the first passage which sucks oil from the intake opening 1402c of the motor unit 2001, the second passage which is provided between the stator 5000 and the rotor 4001, and the third passage which is connected from the second passage to the negative pressure region inside the pump unit 300 and the pump unit 300 discharges the oil flowing from the third passage to the pump unit 300 from the discharge opening 32d.

According to this example embodiment, the oil which is discharged from the discharge opening 32d by the pump rotor 351 and passes through the external device circulates inside the motor unit 2001 through the intake opening 1402c of the motor unit 2001 to simultaneously cool the stator 5000 and the rotor 4001. The oil circulating in the motor unit 2001 is returned to the pump chamber 331 and the pump rotor 351 discharges the oil returned from the motor unit 2001 from the discharge opening 32d. Thus, since it is possible to circulate the oil from the pump unit to the motor unit by a series of passages, it is possible to circulate the oil inside the motor to simultaneously cool the stator and the rotor without decreasing the pump efficiency.

Furthermore, also in this example embodiment, a fourth passage may be provided as the other passages in addition to the first passage to the third passage. In this example embodiment, the fourth passage includes two passages as below as shown in FIG. 9. A first passage 4 is located between the stator 5000 and the shaft 4001, that is, the inside of the stator 5000 and the rotor 4001 in the radial direction. A second passage 4b is located between the rotor 4001 and the side surface 1402a of the housing, that is, the outside of the stator 5000 and the rotor 4001 in the radial direction.

Thus, in this example embodiment, the fourth passage is provided at the inside of the stator 5000 and the rotor 4001 in the radial direction and the outside of the stator 5000 and the rotor 4001 in the radial direction. Furthermore, the fourth passage (the passage 4b) may include a notch portion (not shown) in the inner peripheral surface of the housing 1402. Since it is possible to increase the amount of the oil flowing into the fourth passage when the housing 141 includes the notch portion, it is possible to more efficiently circulate the oil.

Although example embodiments of the disclosure have been described above, the disclosure is not limited to these example embodiments and various modifications and changes can be made within the scope of the spirit thereof.

Priority is claimed on Japanese Patent Application No. 2016-195272, filed Sep. 30, 2016, the content of which is incorporated herein by reference.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-16. (canceled)

17. A pump device comprising:
a shaft that rotates about a center axis extending in an axial direction;
a motor that rotates the shaft; and
a pump that is located at one side of the motor in the axial direction and is driven by the motor through the shaft to discharge oil; wherein
the motor includes a rotor that rotates about the shaft, a stator facing face the rotor, a housing that accommodates the rotor and the stator, and an intake opening provided in the housing to suck the oil;
the pump includes a pump rotor attached to the shaft, a pump casing that accommodates the pump rotor, and a discharge opening that is provided in the pump casing and discharges the oil;
the pump device further comprises:
a first passage that sucks oil from an intake opening of the motor;
a second passage provided between the stator and the rotor; and
a third passage connected from the second passage to a negative pressure region inside the pump; and
the pump discharges the oil flowing from the third passage to the pump from the discharge opening.

18. The pump device according to claim 17, wherein
the pump casing includes a pump cover and a pump body;
the pump body is open at both ends in the axial direction open and the shaft extends therethrough; and
the pump rotor rotates with rotation of the shaft.

19. The pump device according to claim 17, wherein the intake opening is provided in a bottom portion of the housing.

20. The pump device according to claim 17, wherein
the intake opening is provided in a side surface of the housing; and
the intake opening is located between a bottom portion of the housing and one end of the stator opposite to the pump in the axial direction.

21. The pump device according to claim 20, further comprising:
a cover that covers a gap between the side surface of the housing and one end of the stator opposite to the pump in the axial direction.

22. The pump device according to claim 17, wherein the intake opening is located below or above the shaft when the pump device is disposed horizontally in the axial direction.

23. The pump device according to claim 17, wherein the intake opening is provided at a plurality of positions of the housing.

24. The pump device according to claim 17, further comprising:
a fourth passage provided between the stator and the housing.

25. The pump device according to claim 24, wherein the second passage and the fourth passage are joined together and are connected to the fourth passage.

26. The pump device according to claim 24, wherein the fourth passage includes a through-hole or a notch portion provided in the stator or a notch portion provided in the housing.

27. The pump device according to claim 24, wherein
the stator is disposed at an outside of the rotor in a radial direction;
the stator includes a stator core provided with a plurality of teeth separated from each other;
a ring is disposed between the rotor and the stator core;
the fourth passage extends through a gap between adjacent pairs of the teeth of the stator core; and
the second passage extends through an interior in the radial direction in relation to an inner peripheral surface of the ring.

28. The pump device according to claim 17, wherein
the stator is disposed at an outside of the radial direction of the rotor;
the motor includes a ring that is interposed between the pump and the stator in the axial direction;
the ring includes a first through-hole in the axial direction and a second through-hole in the radial direction;
the intake opening is disposed to be connected to the ring;
the first passage includes a conduction portion connected from the intake opening to the second through-hole; and
the fourth passage is connected to the third passage through the first through-hole.

29. The pump device according to claim 17, further comprising:
a fourth passage provided between the stator and the shaft.

30. The pump device according to claim 17, wherein
the shaft passes through a bottom portion of the housing; and
the bottom portion of the housing includes a sliding bearing structure.

31. The pump device according to claim 17, wherein the stator is an integrally molded product made of resin.

32. The pump device according to claim 17, wherein the rotor is an integrally molded product made of resin.
